(19) United States
(12) Patent Application Publication
(10) Pub. No.: US 2022/0162922 A1
(43) Pub. Date: May 26, 2022

(54) System And Method For Real-Time Drilling Or Milling Optimization

(71) Applicant: Baker Hughes Oilfield Operations LLC, Houston, TX (US)

(72) Inventors: Timothy Michael Popp, Houston, TX (US); John Abhishek Raj Bomidi, The Woodlands, TX (US)

(21) Appl. No.: 17/102,605

(22) Filed: Nov. 24, 2020

(51) Int. Cl. E21B 29/06; E21B 44/04; E21B 7/06; E21B 47/09

(52) U.S. Cl. CPC E21B 29/06; E21B 44/04; E21B 2200/20; E21B 47/09; E21B 7/061

(57) ABSTRACT

For milling a window into a casing that has been cemented in a well, a whipstock and a mill bit are connected at the end of a Bottom-Hole-Assembly, which includes downhole sensors. The mill bit cuts an exit window into and out of the casing. Preferably, the operation of the drilling equipment that actuates the mill bit is controlled based on measurements performed by the downhole sensors, and the control takes into account changes in the interface between the mill bit and the material (e.g., the casing steel, the cement) being milled and/or the changes in the volume of milled material as the mill bit penetrates through the casing. The control can minimize a difference between the mechanical specific energy values calculated in real-time and a predetermined target value.

### CROSS-REFERENCE TO RELATED APPLICATIONS

None

### BACKGROUND

This disclosure relates generally to a system and a method for drilling in a well, in particular, for milling a window into a casing that has been cemented in the well.

Completions and intervention milling services are some of the most frequently required operations in the oilfield (e.g., casing exit, section milling, etc.). IADC/SPE paper no. 199612-MS, entitled “Prescriptive Data Analytics to Optimize Casing Exits,” presented at the International Drilling Conference and Exhibition held in Galveston, Texas, on Mar. 3-5, 2020, discloses a data-driven approach that has been developed to improve efficiency, quality, and consistency of milling, which is not only critical to enhancing service delivery but also to maintain wellbore quality for subsequent operations. This paper discloses a system and a method that uses a real-time downhole measurement tool in conjunction with a real-time surface monitoring system to provide real-time alerts and recommendations for milling operating parameters. Downhole measurements (e.g., Weight-On-Bit, Torque-On-Bit, vibration, etc.) are acquired close to the mill bit and communicated to the surface using conventional telemetry methods (e.g., mud-pulse, acoustic, wired-pipe, Electro-Magnetic, etc.). The downhole measurements, as well as the measurements read by the surface monitoring system, undergo analysis using modeling techniques. The models may rely on analytical or machine learning methods. The output of the models provides a real-time prediction of the milling performance and a real-time prescription for operating parameter control. These processes occur continuously throughout milling so that the operating parameters are controlled along the entire length of the whipstock ramp. Adjustment recommendations are based on physical controls available to the rig operator (e.g., block height, run-in speed, Weight-On-Bit, Rotation-Per-Minute, flow rate, etc.). The controls are designed to keep the milling performance within certain operating thresholds (e.g., Rate-Of-Penetration, vibration levels, Weight-On-Bit, Torque-On-Bit, etc.). This process is a continuous feedback process where downhole measurements are taken, optimal conditions are confirmed or rejected, adjustments are prescribed, new downhole conditions are predicted and measured, and the process repeats. This process is superior to traditional techniques because operating parameter adjustments are currently based on surface measurements and not downhole measurements. It has been shown in the literature that surface measurements do not accurately represent downhole measurements. These surface measurements result in inaccurate and erroneous decision making at the rig. The approach has been tested in several operator wells for casing exit applications. A recommended milling schedule was provided to the rig before the job, which included a schedule for downhole Weight-On-Bit and Rotation-Per-Minute at incremental positions along the whipstock. A downhole measurement tool was used to collect and transmit real-time data to the surface. The real-time downhole measurements were then used to adjust the operating parameters to follow the milling schedule. In several jobs, this method resulted in a reduction in vibration by 30%, an increase in Rate-Of-Penetration of 14%, and a reduction in total milling time by 23%. The method also reduced the window drag by an average of 50%.

Despite these advances, an understanding of the milling process and the ability to optimize performance using physics-based models are lacking.

Thus, there is a continuing need in the art for a system and a method that achieve real-time milling optimization that better integrates the physics of the milling process.

### BRIEF SUMMARY OF THE DISCLOSURE

The disclosure describes a system for controlling the milling of an exit window through a casing using a whipstock.

The system may comprise a simulator capable of receiving data indicative of a position of a bit coupled to a string. The simulator may be programmed to simulate values indicative of an incremental amount of volume of milled casing. For example, volumes corresponding to an envelope of the bit may be simulated using a whipstock geometry and a profile of the bit, as a function of several values of the position of the bit; volumes corresponding to the casing may be simulated using casing geometry; and then, the values indicative of an incremental amount of volume of milled casing may be calculated using simulated intersections of the volumes corresponding to an envelope of the bit with the volumes corresponding to the casing. Optionally, the simulator may be programmed to simulate values indicative of an area of an interface between the casing and the mill bit. For example, the values indicative of the area of the interface between the casing and the mill bit may be calculated using simulated intersections of the volumes corresponding to an envelope of the bit with the volumes corresponding to the casing. Alternatively, the values indicative of the area of the interface between the casing and the mill bit may be calculated using the values indicative of the incremental amount of volume of milled casing and rate-of-penetration. In some embodiments, the profile of the bit may be approximated and may include at least a portion of a rectangle, an ellipsis, or a semi-circle.

The system may preferably comprise downhole sensors for measuring a weight-on-bit applied by the string, and a torque-on-bit applied by the string and a rotation-per-minute.

The system may comprise a computer programmed to calculate mechanical specific energy values in real-time. The computer may be programmed to calculate the mechanical specific energy values in real-time using the values indicative of an incremental amount of volume of milled casing and drilling parameters measured during the milling of the exit window. Alternatively or additionally, the computer may be programmed to calculate the mechanical specific energy values in real-time using values indicative of an area of an interface between the casing and the mill bit. The computer is further programmed to calculate depth-of-cut values in real-time using the values indicative of the area of the interface between the casing and the mill bit. Preferably, the computer may be programmed to calculate the mechanical specific energy values in real-time using the weight-on-bit and torque-on-bit, and the rotation-per-minute measured by the downhole sensors. Optionally, the computer may be programmed to calculate depth-of-cut values in real-time using the values indicative of the area of the interface between the casing and the mill bit.

The system may comprise a controller programmed to adjust operation of drilling equipment such that a difference between the mechanical specific energy values calculated in real-time and a predetermined target value is minimized. Optionally, the controller may be programmed to adjust the operation of drilling equipment such that a difference between the depth-of-cut calculated in real-time and a predetermined target value is minimized. For example, the controller may be programmed to calculate target values for weight-on-bit applied by the string and a torque-on-bit applied by the string such that a difference between the mechanical specific energy values calculated in real-time and a predetermined target value is minimized. The controller may further be programmed to adjust operation of drilling equipment such that a difference between the weight-on-bit and torque-on-bit measured by the downhole sensors and the target values for torque-on-bit applied by the string are minimized.

The disclosure also describes a method for milling an exit window through a casing using a whipstock. The method may comprise the step of providing data indicative of a position of a bit coupled to a string. The method may comprise the steps of providing a simulator, a computer, and a controller as described above. The method may comprise the step of controlling the milling of the exit window using the simulator, the computer, and the controller.

The disclosure describes a system for controlling drilling in a well.

The system may comprise a sensor capable of measuring data indicative of a position of a bit coupled to a string.

The system may comprise a computer programmed to calculate mechanical specific energy values in real-time. For example, the computer may be programmed to calculate the mechanical specific energy values in real-time using a total volume of material swept by the mill bit and drilling parameters measured during the milling of the exit window. The total volume of material may include casing, cement, and rock.

The system may comprise a controller programmed to adjust operation of drilling equipment such that a difference between the mechanical specific energy values calculated in real-time and a predetermined target value is minimized. For example, the controller may be programmed to calculate target values for weight-on-bit applied by the string and a torque-on-bit applied by the string such that a difference between the mechanical specific energy values calculated in real-time and a predetermined target value is minimized. The controller may be programmed to adjust operation of drilling equipment such that a difference between the weight-on-bit and torque-on-bit measured by the downhole sensors and the target values for torque-on-bit applied by the string are minimized.

### BRIEF DESCRIPTION OF THE DRAWINGS

For a more detailed description of the embodiments of the disclosure, reference will now be made to the accompanying drawings, wherein:

FIG. 1 is a flowchart of a method for real-time milling;

FIG. 2 illustrates the simulation of a mill bit 28 using a geometry model;

FIG. 3A-3D illustrates the simulation of increments of volume of milled casing and interfaces between the mill bit and the casing;

FIG. 4 is a diagram of a system for controlling the milling of an exit window through a casing;

FIGS. 5A-5B are sequential views of a Bottom-Hole-Assembly, including a mill bit, as the mill bit penetrates through a casing; and

FIG. 6 is a view of a rig site implementing a system for milling a window into a casing.

### DETAILED DESCRIPTION

It is to be understood that the disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Additionally, the exemplary embodiments presented below may be combined in any combination of ways, i.e., any element from one exemplary embodiment may be used in any other exemplary embodiment, without departing from the scope of the disclosure. Finally, all numerical values in this disclosure may be approximate values unless otherwise specifically stated. Accordingly, various embodiments of the disclosure may deviate from the numbers, values, ranges, and proportions disclosed herein or illustrated in the Figures without departing from the intended scope.

This disclosure describes a system and a method for milling a window into a casing that has been cemented in a well. A whipstock and a mill bit are connected at the end of a Bottom-Hole-Assembly, which preferably includes downhole sensors. The whipstock is oriented and then anchored to the casing. The mill bit starts rotating and sliding over the whipstock along a trajectory that is angled relative to the axis of the casing. The trajectory intersects the casing on one side of the well. The mill bit cuts an exit window into and out of the casing. In order to optimize milling efficiency, the operation of drilling equipment that actuates the mill bit is controlled based on measurements performed preferably by the downhole sensors. The control is based on a modified Mechanical-Specific-Energy and/or a modified Depth-Of-Cut that are representative of the physics of milling the casing. Indeed, the casing is usually made of steel, which is much stronger than cement, rock, or other materials milled by the mill bit. Therefore, most of the mechanical energy transferred to the mill bit is consumed by milling the casing. The control takes into account changes in the position and area of the interface between the mill bit and the casing and/or the changes in the increment of volume of the milled casing as the mill bit progressively penetrates through the casing. An example calculation of the modified Mechanical-Specific-Energy and the modified Depth-Of-Cut are further described hereinbelow.

A duration, noted δt, is selected. This duration can represent a small time interval that is used to smooth data that usually jitter.

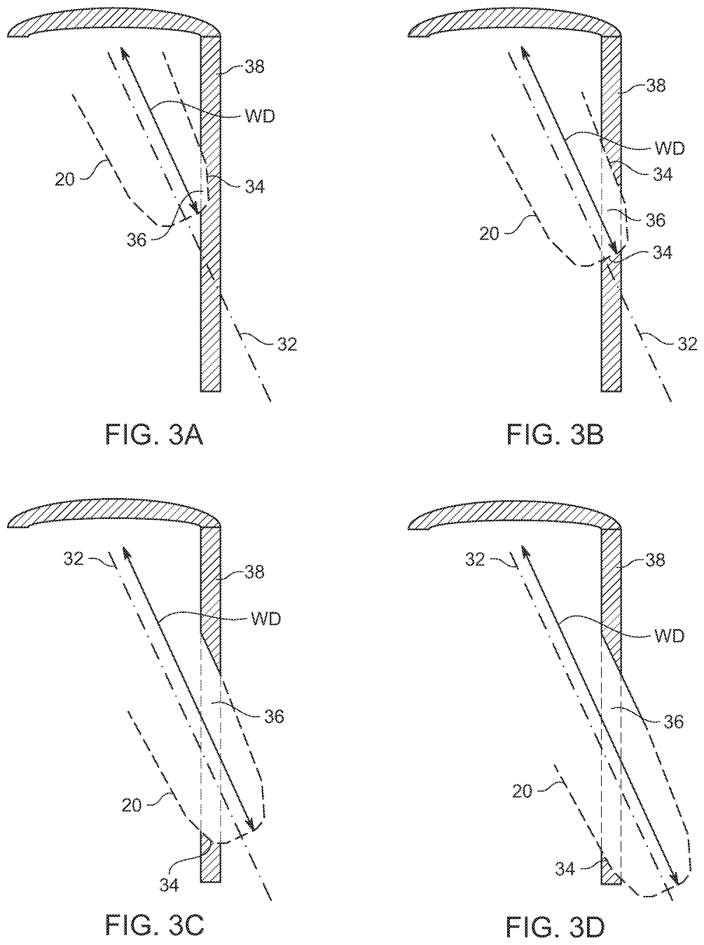

An incremental amount of volume of milled casing, noted δV, that is milled by the mill bit during the preselected duration, is simulated using geometry modeling. Referring briefly to FIGS. 3A-3D, it can be seen that the geometry modeling takes into account the changes in the position and area of the interface between the mill bit and the casing and/or the changes in the incremental amount of volume of milled casing as the mill bit progressively penetrates through the casing. In particular, the fraction of the volume of casing in the total volume swept by the mill bit during the preselected duration is not necessarily constant as the mill bit penetrates through the casing.

In some embodiments, an advancement of the mill bit into the casing, noted δl, which is indicative of the distance that the mill bit travels along the bit trajectory during the preselected duration, is calculated using the relationship shown in the Equation below:

δl=ROP*δt

wherein ROP is a value indicative of the Rate-Of-Penetration during the preselected duration, and δt is the preselected duration.

A modified value indicative of the area of the interface between the casing and the mill bit, noted Areaₘ, is calculated by dividing the incremental volume of casing milled by the mill bit during the preselected duration by the advancement of the mill bit into the casing, as shown in the Equation below:

$$A r e {a}_{m} = \frac{δ V}{δ l}$$

In order to calculate a Depth-Of-Cut, noted DOC, the advancement of the mill bit into the casing is divided by the number of time a blade of the mill bit passes any fixed direction, which is the product of the number of the blades of the mill bit by the Rotation-Per-Minute and by the preselected duration. The Depth-Of-Cut is calculated as shown in the Equation below:

$$D O C = \frac{δ l}{N * R P M * δ t} = \frac{ROP}{N * R P M}$$

wherein N is the number of the blades of the mill bit, RPM is a value indicative of the Rotation-Per-Minute during the preselected duration and is preferably measured downhole, and ROP is the value indicative of the Rate-Of-Penetration during the preselected duration. Note that this value of the Depth-Of-Cut is the classical value and does not take into account the changes in the interface between the mill bit and the casing.

In order to calculate a modified Mechanical-Specific-Energy, a formula similar to the classical formula for the Mechanical-Specific-Energy is used, but with the cross-area of the bit replaced by the modified value indicative of the area of the interface between the casing and the mill bit, as shown in the Equation below:

$$M S {E}_{m} = \frac{WOB}{A r e {a}_{m}} + \frac{2 π * TOB * R P M}{A r e {a}_{m} * ROP}$$

wherein MSEₘ is the modified Mechanical-Specific-Energy, WOB is a value indicative of the Weight-On-Bit during the preselected duration and is preferably measured downhole, Areaₘ is the modified value indicative of the area of the interface between the casing and the mill bit calculated above, RPM is a value indicative of the Rotation-Per-Minute during the preselected duration and is preferably measured downhole, TOB is a value indicative of the Torque-On-Bit during the preselected duration and is preferably measured downhole, and ROP is the value indicative of the Rate-Of-Penetration during the preselected duration.

Accordingly, the modified Mechanical-Specific-Energy MSEₘ calculated above can take into account the changes in the position and area of the interface between the mill bit and the milled casing and/or the changes in the increment of volume of milled casing as the mill bit progressively penetrates through the casing.

In other embodiments, an interface between the casing and the mill bit is also simulated using geometry modeling. A modified value indicative of the area of the interface, still noted Areaₘ, is calculated from the simulations, for example, as an average of the area over the preselected duration, an initial value or final value of the area during the preselected duration, or other estimates representative of the area during the preselected duration. Referring briefly to FIGS. 3A-3D, it can be seen that the fraction of the area of the interface between the casing and the mill bit in the envelope of the mill bit is not necessarily constant as the mill bit penetrates through the casing.

A modified advancement of the mill bit into the casing is calculated by dividing the incremental amount of volume of casing milled by the mill bit during the preselected duration by the modified value indicative of the area of the interface, as shown in the Equation below:

$$δ {l}_{m} = \frac{δ V}{A r e {a}_{m}}$$

wherein δlₘ is the modified advancement of the mill bit into the casing, and δV is the incremental amount of volume of casing milled by the mill bit during the preselected duration, which was also computed from simulations as explained above.

In order to calculate a modified Depth-Of-Cut, the modified advancement of the mill bit is divided by the number of times a blade of the mill bit passes any fixed direction, which is the product of the number of blades of the mill bit by the Rotation-Per-Minute and by the preselected duration. Thus, the modified Depth-Of-Cut, noted DOCₘ, is calculated as shown in the Equation below:

$${DOC}_{m} = \frac{δ {l}_{m}}{N * R P M * δ t}$$

wherein N is the number of the blades of the mill bit, and RPM is a value indicative of the Rotation-Per-Minute preferably measured downhole during the preselected duration.

Accordingly, the modified Depth-Of-Cut can take into account the changes in the position and area of the interface between the mill bit and the casing and/or the changes in the increment of volume of milled casing as the mill bit progressively penetrates through the casing.

In order to calculate the modified Mechanical-Specific-Energy, the mechanical energy is first calculated from the mechanical power transferred to the mill bit. The mechanical power can be calculated from downhole measurements collected over time as shown in the Equation below:

P=WOB*ROP+2π*TOB*RPM

wherein the mechanical power, noted P, is the sum or a term caused by the advancement of the mill bit, and a term caused by rotation of the mill bit; the term caused by the advancement of the mill bit is the product of the Rate-Of-Penetration, still noted ROP, by the Weight-On-Bit, still noted WOB, which is preferably measured downhole; the term caused by the rotation of the mill bit is the product of the Rotation-Per-Minute, still noted RPM, by the Torque-On-Bit, still noted TOB, both preferably measured downhole. The mechanical energy transferred to the mill bit during the preselected duration can be calculated by integration of the mechanical power with respect to time over the preselected duration. The modified Mechanical-Specific-Energy is calculated by dividing the mechanical energy transferred during the preselected duration by the incremental volume of casing milled by the mill bit during this preselected duration, as shown in the Equation below:

$$M S {E}_{m} = \frac{{\int }_{δ t} P d t}{δ V}$$

Again, the modified Mechanical-Specific-Energy MSEₘ calculated above takes into account the changes in the position and area of the interface between the mill bit and the casing and/or the changes in the increment of volume of milled casing as the mill bit progressively penetrates through the casing.

The system and method for milling a window into the casing rely on a controller programmed to adjust the operation of the drilling equipment such that a difference between the modified Mechanical-Specific-Energy values calculated in real-time and a predetermined target value is minimized. Optionally, the controller is additionally or alternatively programmed to adjust the operation of the drilling equipment such that a difference between the Depth-Of-Cut values calculated in real-time and a predetermined target value is minimized. Unlike other target values, which can vary significantly as the mill bit progressively penetrates through the casing, target values for Mechanical-Specific-Energy and Depth-Of-Cut may not vary excessively, and controlling the drilling equipment to attain these values is expected to better integrate the physics of the milling process. Conveniently, but not necessarily, the operation of the drilling equipment is adjusted via at least one of the operating parameters such as Weight-On-Bit, and Rotation-Per-Minute.

In order to identify the target value of the modified Mechanical-Specific-Energy and/or the target value of the Depth-Of-Cut, the system and method disclosed herein can utilize one or more empirical model(s) that are tuned for predicting parameters indicative of milling efficienciency as a function of well geometry, Bottom-Hole-Assembly and mill bit configuration, and the control parameters, which are the modified Mechanical-Specific-Energy and/or Depth-Of-Cut. The target values for the control parameters can be identified by minimizing the value of a cost function that penalizes inefficient milling. The cost function is calculated from the prediction by the one or more empirical model(s) of the parameters indicative of milling efficiency. However, other methods of identifying target values for modified Mechanical-Specific-Energy and Depth-Of-Cut may be used instead of tuning empirical models and minimizing a cost function that penalizes inefficient milling. For example, the target value of the Depth-Of-Cut can be identified from the geometry of the elements of the mill bit that are used to cut or abrade the casing, the cement, and the rock, and the target value of the modified Mechanical-Specific-Energy can be identified from the strength of the steel making the casing and the target value of the Depth-Of-Cut.

If the one or more empirical model(s) are used, their tuning can be performed by utilizing historical data, for example, in a way similar to the one described in the IADC/SPE paper no. 199612-MS. For example, the well data can include historical data for casing size, casing weight, casing grade, well inclination (also called hole angle), cement characteristics, such as cement thickness, exit type, kick-off depth, or distance to be milled. The Bottom-Hole-Assembly and mill bit configuration can be described with corresponding historical data for mill bit type, whipstock angle, and position of stabilizers in the Bottom-Hole-Assembly, if used. The parameters indicative of milling efficiency can include historical data for the time needed to mill a specified portion of a casing exit window and/or the Rate-Of-Penetration achieved when milling the specified portion of a casing exit window, the vibration level observable in the Bottom-Hole-Assembly when milling the specified portion of a casing exit window, the bending of the Bottom-Hole-Assembly observable when milling the specified portion of a casing exit window, and the Torque-On-Bit observable when milling the specified portion of a casing exit window. The parameters indicative of milling efficiency can be functions of the Whipstock Depth, which is indicative of a position of the mill bit along the whipstock that is scaled between 0, at the top of the whipstock, and 1, at the bottom of the whipstock.

One difference from the process described in IADC/SPE paper no. 199612-MS, where the control parameters are Weight-On-Bit and Rotation-Per-Minute of the Bottom-Hole-Assembly, the control parameters utilized herein include a modified Mechanical-Specific-Energy and/or a Depth-Of-Cut. These control parameters are calculated as described hereinabove, that is, the modified Mechanical-Specific-Energy and optionally the Depth-Of-Cut take into account changes in the interface between the mill bit and the casing and/or the increment of casing volume that is milled. The control parameters derived from the historical data can also be functions of the Whipstock Depth.

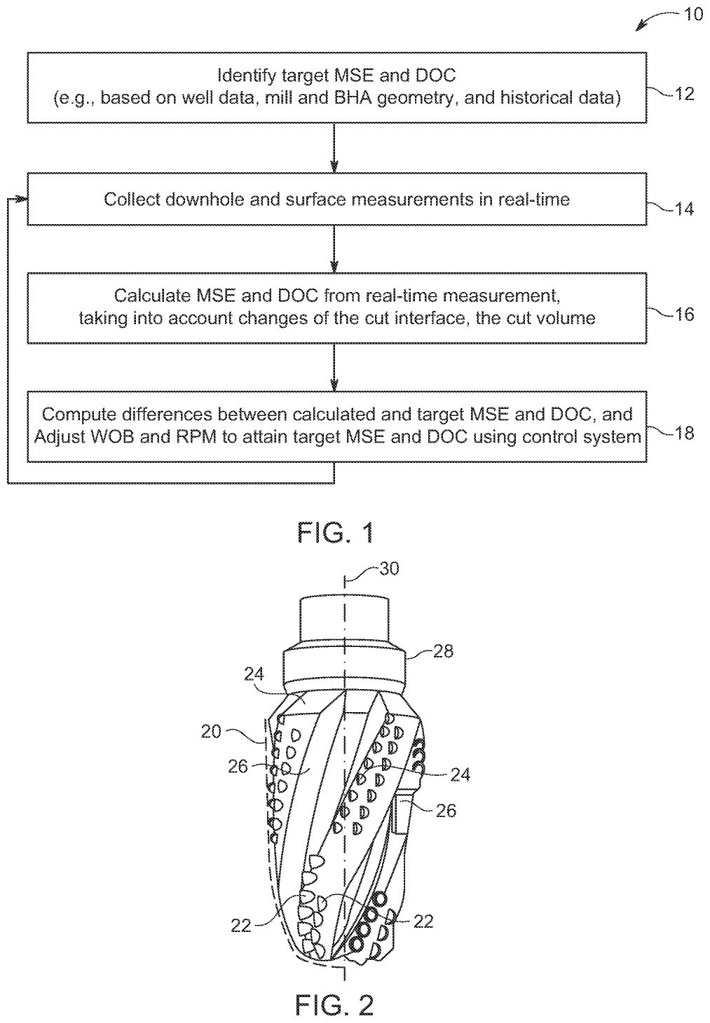

FIG. 1 shows a flowchart 10, illustrating an example of a method for real-time milling optimization.

At step 12, target values for modified Mechanical-Specific-Energy and Depth-Of-Cut are identified, for example, based on well data, Bottom-Hole-Assembly and mill bit configuration, and historical data. For example, with well data that is known from the job to be performed, an optimum value for the Bottom-Hole-Assembly and mill bit configuration and the target values for modified Mechanical-Specific-Energy and Depth-Of-Cut can be determined using the one or more tuned model(s) and the cost function described hereinabove. However, other methods of identifying target values for modified Mechanical-Specific-Energy and Depth-Of-Cut may be used.

At step 14, downhole and surface measurements are collected in real-time. The downhole measurements are performed by sensors located near the mill bit in the Bottom-Hole-Assembly. The downhole measurements preferably include at least Weight-On-Bit, Torque-On-Bit, and Rotation-Per-Minute. The downhole measurements are broadcasted to a computer located near the drill string using telemetry. The surface measurements are performed by sensors located near the drill rig. The surface measurements preferably include at least the position of the top drive (also called block height) and/or vertical speed of the top drive (also called run-in speed), which can be measured on the drawworks that suspends the drill string and/or the top drive in the well.

A Driller Depth or other equivalent data, indicative of the position of the mill bit along its trajectory, can be derived from the position of the top drive, the nominal length of the drill string, and the phenomena that contribute to the elongation or shortening of the drill string (e.g., thermal expansion, the weight of the drill string, buoyancy forces). As mentioned before, Whipstock Depth may be derived from and used instead of the Driller Depth. A Rate-Of-Penetration can be derived from the Driller Depth using a derivative with respect to time. Alternatively, chalk lines may be drawn on the drill string at regular intervals, starting when the mill bit is at the top of the whipstock. The distance traveled by the drill string relative to the top of the whipstock may thus be measured by an operator. Whipstock Depth can also be calculated using the measurements performed by the operator.

At step 16, a modified Mechanical-Specific-Energy and a Depth-Of-Cut are calculated by taking into account changes in the position and area of the interface between the mill bit and the casing and/or the changes in the increment of volume of milled casing as the mill bit progressively penetrates through the casing.

A duration (i.e., δt), for example, one second, ten seconds, is preselected. An incremental amount of volume (i.e., δV) of casing milled by the mill bit during the preselected duration is simulated, as further explained in the description of FIGS. 2 and 3A-3D. Optionally, an interface between the casing and the mill bit is also simulated, as further explained in the description of FIGS. 2 and 3A-3D, and a modified value indicative of the area (i.e., Areaₘ) of the interface is calculated from the simulations.

The incremental volume, and optionally the area, are preferably used together with the downhole measurements to calculate a real-time value of the modified Mechanical-Specific-Energy (i.e., MSEₘ), and, optionally, a real-time value of the modified Depth-Of-Cut (i.e., DOCₘ) as disclosed hereinabove. Alternatively, some surface measurements may be used instead of downhole measurements to calculate the real-time value of the modified Mechanical-Specific-Energy and the real-time value of the Depth-Of-Cut.

At step 18, the difference between the real-time value of the modified Mechanical-Specific-Energy calculated at step 16 and the target value for the modified Mechanical-Specific-Energy identified at step 12 is computed. The difference between the real-time value of the Depth-Of-Cut calculated at step 16 and the target value for the Depth-Of-Cut identified at step 12, is also computed. A control system can utilize the values of one or more of the differences, and optionally, previous values of one or more of the differences to determine target values of operating parameters such as a Weight-On-Bit (i.e., WOB) and a Rate-Per-Minute (i.e., RPM) so that to the differences are minimized, that is, the real-time value of the modified Mechanical-Specific-Energy attains the target value of the Mechanical-Specific-Energy, and the real-time value of the Depth-Of-Cut attains the target value of the Depth-Of-Cut. The target values of the operating parameters are then used to adjust the operation of the drilling equipment provided on the rig, for example, as is known in the art.

The steps 14, 16, and 18 may be reiterated until the milling of the exit window in the casing is accomplished.

FIGS. 2 and 3A-3D show schematics illustrating an exemplary way by which the incremental volume of casing milled by the mill bit and of the interface between the casing and the mill bit are simulated using geometry modeling. For the sake of simplicity, these schematics are bidimensional; however, the simulations are preferably tridimensional.

FIG. 2 shows a mill bit 28, which could be the mill bit selected at step 12 of the flow chart 10 shown in FIG. 1. The mill bit 28 includes several blades 24, separated by waterways 26. Elements 22 are provided on the blades 24 to cut or abrade the casing, the cement, and the rock as the exit window is milled through the casing. For simplifying the simulation of the mill bit 28, a profile 20 of the mill bit 28 can be rotated around axial axis 30 in the simulator to create a volumetric envelope of the mill bit 28, which may thus be smooth. However, the simulation of the mill bit 28 may be performed without creating a smooth volumetric envelope of the mill bit 28. For example, the profile of the mill bit may be approximated based on the maximum diameter of the bit. Thus, the approximation of the profile of the mill bit may consists of a rectangle having a width equal to the maximum diameter of the bit. Other approximations of the profile of the mill bit may also be used, such as approximations that includes at least a portion of a rectangle, an ellipsis, or a semi-circle that have a width equal to the maximum diameter of the bit.

FIGS. 3A-3D show schematics illustrating simulations of the geometry of the well, including a casing 38, and optionally, cement and Earth rock, as well as the geometry of the mill bit, including the profile 20. The simulations are performed during the milling process, and the Figures represent snapshots of the simulated geometry for successive positions of the mill bit, which is represented schematically by the profile 20 in the Figures. The successive positions of the mill bit can be indexed using the Driller Depth, or the Whipstock Depth, which is represented by the distance WD in FIGS. 3A-3D. These successive positions occur at corresponding times, which are the times at which the Driller Depth, or the Whipstock Depth, is such that the mill bit is located at these positions. For clarity purposes, the successive positions of the mill bit illustrated in the FIGS. 3A-3D are spaced apart. Additional intermediate positions would typically be simulated. Preferably, the positions that are simulated would correspond to times that are separated by intervals that are at least as small as the preselected duration (i.e., δt).

In the sequence of FIGS. 3A-3D, the mill bit slides over the whipstock (not shown) along a trajectory 32 that is angled relative to the axis of the casing 38. The volumes corresponding to the envelope of the mill bit are simulated for four example values of the Whipstock Depth WD. These simulations usually depend on the whipstock angle, or, more generally, the whipstock geometry, and the shape of the profile 20, or, more generally, the shape of the mill bit. The volumes corresponding to the envelope of the mill bit are simulated for several values of the position of the mill bit. Together with each of the volumes corresponding to the envelope of the mill bit, the geometry of the casing 38 is also simulated. These simulations usually depend on the casing sizes (e.g., inner diameter and thickness). Each of the interface 34 between the casing 38 and the mill bit can be determined by simulating the intersection of each of the envelopes of the mill bit with the geometry of the casing. Also, each of the volume 36 of milled casing can be determined by simulating the intersection of each of the volumes corresponding to the envelope of the mill bit with the geometry of the casing. The interface 34 between the casing 38 and the mill bit delimits the volume 36 of milled casing. Note that only a section of the interface 34 (i.e., a line or lines) and a section of the volume 36 (i.e., a surface) are shown in the bidimensional illustrations of FIGS. 3A-3D; however, when the simulations are tridimensional, the interface 34 is a surface delimiting the volume 36. Then, an incremental amount of volume (i.e., δV) of casing milled by the mill bit is calculated by subtracting the volume 36 simulated at a preceding position of the mill bit from the volume 36 simulated at the current position of the mill bit. A modified value indicative of the area of the interface (i.e., Areaₘ) can be calculated as an average of the area of the interface 34 at the preceding position of the mill bit and at the current position of the mill bit, or as the area of the interface 34 at the preceding position of the mill bit, or as the area of the interface 34 at the current position of the mill bit. Indeed, when the preselected duration (i.e., δt) is sufficiently small, these three calculations become similar. Other estimates representative of the area of the interface 34 between the preceding position of the mill bit and at the current position of the mill bit can also be used to calculate the modified value indicative of the area of the interface.

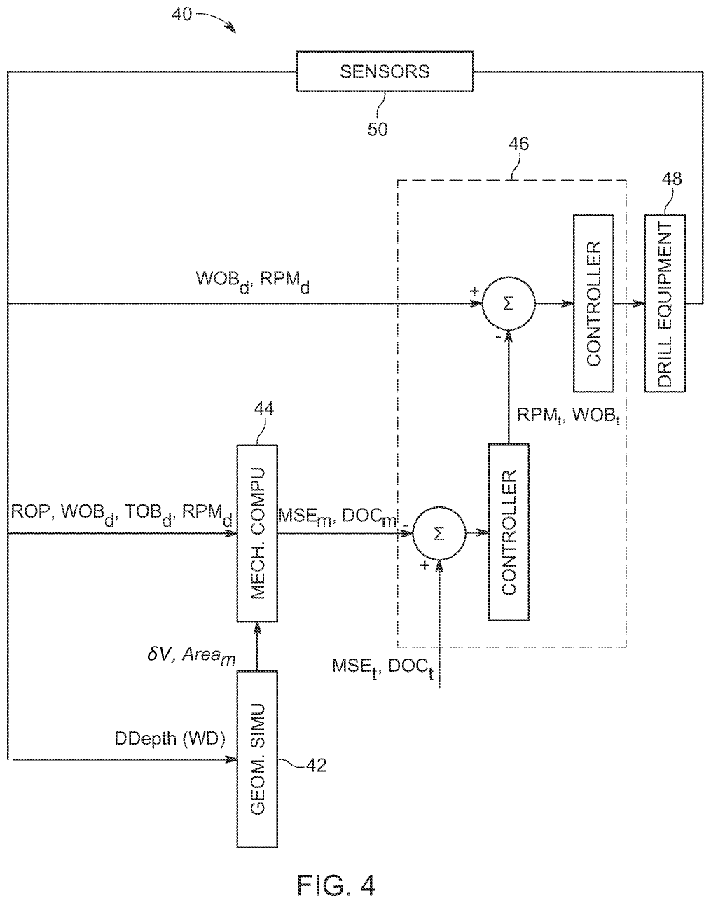

FIG. 4 shows a diagram of an example system 40 for controlling the milling of an exit window through a casing using a whipstock.

The system 40 includes a simulator 42. The simulator 42 receives real-time data indicative of a position of a mill bit coupled to a drill string. The data can be, for example, Driller Depth or Whipstock Depth. The real-time data indicative of the position of the mill bit may be received from a sensor. Alternatively, the real-time data indicative of the position of the mill bit may be measured by an operator and entered in real-time on the simulator. The simulator 42 is programmed to calculate at least an incremental amount volume of milled casing (i.e., δV), as explained in the description of FIGS. 3A-3B. Optionally, the simulator 42 is also programmed to calculate a modified value indicative of the area of the interface between the casing and the mill bit (i.e., Area.). The incremental amount volume of milled casing and the modified value indicative of the area of the interface between the casing and the mill bit are transmitted to a computer 44. The computer 44 also receives operating parameters measured during the milling of the exit window. Preferably, the operating parameters include a value indicative of Rate-Of-Penetration (i.e., ROP), Weight-On-Bit measured downhole (i.e., WOB_{b}), Torque-On-Bit measured downhole (i.e., TOB_{d}), and Rotation-Per-Minute measured downhole (i.e., RPM_{d}). The computer 44 is programmed to calculate a real-time value of the modified Mechanical-Specific-Energy (i.e., MSEₘ), and either a Depth-Of-Cut (i.e., DOC) or a modified Depth-Of-Cut (i.e., DOCₘ). These control parameters are transmitted to a controller 46. The controller also receives target values for modified Mechanical-Specific-Energy and either for Depth-Of-Cut or modified Depth-Of-Cut, which may have been predetermined at step 12 of the flow chart 10 shown in FIG. 1. The controller is programmed to adjust the operation of the drilling equipment 48 (e.g., top drive, drawwork, circulation pumps, etc.) such that a difference between the Mechanical-Specific-Energy and/or Depth-Of-Cut values calculated in real-time and the target value are/is minimized. Preferably, the controller first determines a target value for the Weight-On-Bit and Rotation-Per-Minute such that the difference between the Mechanical-Specific-Energy and/or Depth-Of-Cut values calculated in real-time. Then, the controller adjusts the operation of the drawwork (e.g., adjusts the block height or the run-in speed) and/or operation of the circulation pumps (e.g., adjusts the flow rate) such that a difference between the Weight-On-Bit value measured downhole and the determined target is minimized. Also, the controller adjusts the operation of the top drive (e.g., adjusts the Rotation-Per-Minute) such that a difference between the Rotation-Per-Minute value measured downhole and the determined target value is minimized. Although not shown in FIG. 4, the controller 46 can be constrained so that the drilling equipment 48 is not driven beyond its specifications. The operational state of the drilling equipment 48, in turn, modifies the measurements by the sensors 50 (e.g., downhole or surface sensors) of the operating parameters. There are several control schemes known in the art that can be implemented in the controller 46.

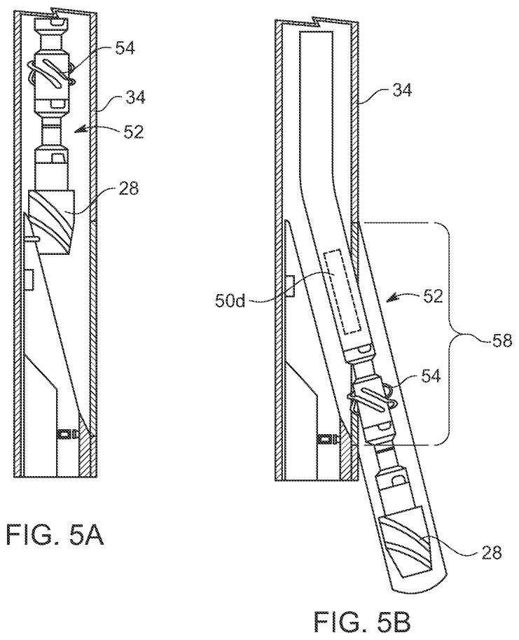

FIGS. 5A and 5B show sequential views of an example Bottom-Hole-Assembly 52, including the mill bit 28, a reamer 54, and downhole sensors 50d, as the mill bit 28 progressively penetrates through the casing 32. A whipstock 56 was oriented and then anchored to the casing 34. In FIG. 5A, the mill bit 28, while rotating, slides over the whipstock 56 along a trajectory that is angled relative to the axis of the casing 34. The trajectory intersects the casing 34 on one side of the well. In FIG. 5B, the mill bit 28 has cut an exit window 58 into and out of the casing 34.

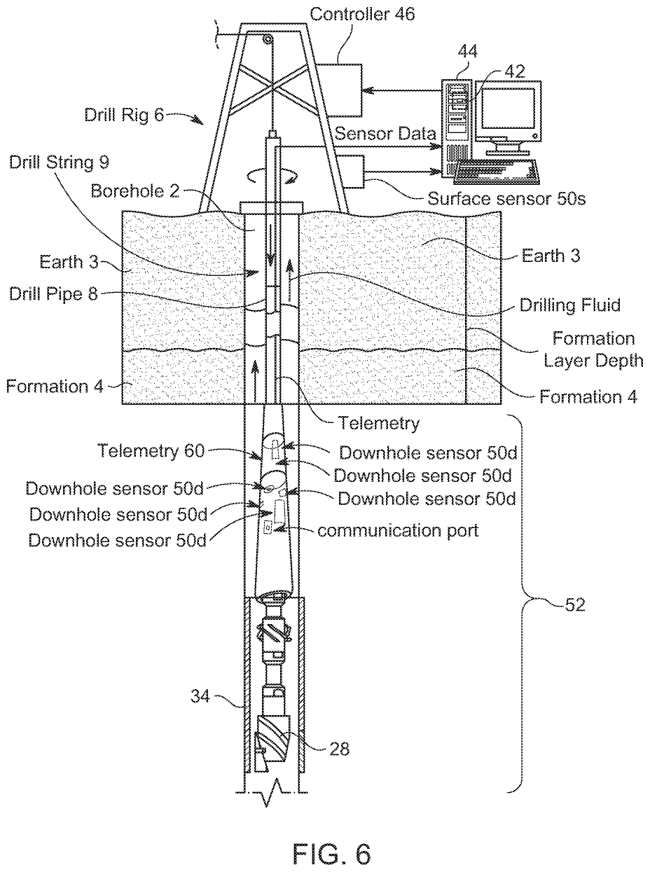

FIG. 6 shows a view of an example rig site where the system for milling a window into a casing can be implemented. The drill site includes a drill rig 6, suspending a drill string 9 into a well (or borehole) 2 that has been drilled through the Earth 3. A casing 34 has been cemented into the well 2.

The drill string 9 includes drill pipes 8 and the Bottom-Hole-Assembly 52. The Bottom-Hole-Assembly 52 includes the mill bit 38 and downhole sensors 50d, which may provide measurements such as Weight-On-Bit, Torque-On-Bit, and bending (also called curvature or dogleg severity), which can be obtained using strain gauges sampled at a high sampling rate and statistical processing. The downhole measurements can further include vibration level, which can be obtained using accelerometers sampled at a high sampling rate and statistical processing. The downhole measurements can further include Rotation-Per-Minute, which can be obtained using magnetometers. The downhole measurements can further include Annular Pressure, Bore Pressure, and temperature, which can be obtained from resonant crystals. The downhole measurements are broadcasted to the computer 44 located near the drill rig 6 using telemetry 60. Fewer or more measurements may be collected depending on the Bottom-Hole-Assembly 52.

The drill site includes surface sensors 50s, which may provide measurements such as tension in the drill string, and position of the top drive (also called block height) and/or vertical speed of the top drive (also called run-in speed), which can be measured on the drawworks that suspends the drill string and/or the top drive in the well. A Weight-On-Bit can be derived from the tension and forces applied to the drill string (e.g., the weight of the drill string, buoyancy forces); however, this Weight-On-Bit is often less accurate than the Weight-On-Bit measured downhole. The surface measurements can further include Rotation-Per-Minute and Torque, which can be measured at the top drive. A Rotation-Per-Minute and Torque-On-Bit can be derived from the Rotation-Per-Minute and Torque measured at the top drive; however, this Rotation-Per-Minute and Torque-On-Bit are often less accurate than the Rotation-Per-Minute, and Torque-On-Bit measured downhole. The surface measurements can further include drilling fluid flow rate and pressure, which can be measured near the circulation pumps. The surface measurements can further include drilling fluid density and drilling fluid temperature. Fewer or more measurements may be collected depending on the drill rig 6.

The simulator 42 may be implemented as a program run on the computer 44.

While FIGS. 1-6 describes a system and a method for milling a window into a casing that has been cemented in a well, some aspects of the description can be applied more generally, such as for drilling a well. For example, a system for controlling drilling may comprise a computer programmed to calculate conventional values of mechanical specific energy values in real-time; and a controller programmed to adjust the operation of drilling equipment such that a difference between the mechanical specific energy calculated in real-time and a predetermined target is minimized. The conventional values of the mechanical specific energy values may be calculated using a total volume of material swept by the mill bit and drilling parameters measured during drilling. In particular, during the milling of the exit window, the total volume of material can include casing, cement, and rock.

The claimed invention is susceptible to various modifications and alternative forms, specific embodiments thereof are shown by way of example in the drawings and description. It should be understood, however, that the drawings and detailed description thereto are not intended to limit the claims to the particular form disclosed, but on the contrary, the intention is to cover all modifications, equivalents, and alternatives falling within the scope of the claims.

What is claimed is:

1. A system for controlling milling of an exit window through a casing using a whipstock, the system comprising:
a computer programmed to calculate mechanical specific energy values in real-time; and
a controller programmed to adjust operation of drilling equipment such that a difference between the mechanical specific energy values calculated in real-time and a predetermined target value is minimized.

2. The system of claim 1, further comprising a simulator capable of receiving data indicative of a position of a bit coupled to a string and programmed to simulate values indicative of an incremental amount of volume of milled casing,
wherein volumes corresponding to an envelope of the bit are simulated using a whipstock geometry, and a profile of the bit, as a function of several values of the position of the bit,
wherein volumes corresponding to the casing are simulated using casing geometry,
wherein the values indicative of an incremental amount of volume of milled casing are calculated using simulated intersections of the volumes corresponding to an envelope of the bit with the volumes corresponding to the casing, and
wherein the computer is programmed to calculate the mechanical specific energy values in real-time using the values indicative of an incremental amount of volume of milled casing and drilling parameters measured during the milling of the exit window.

3. The system of claim 2, wherein the profile of the bit is approximated and includes at least a portion of a rectangle, an ellipsis, or a semi-circle.

4. The system of claim 2,
wherein the computer is programmed to calculate the mechanical specific energy values in real-time using values indicative of an area of an interface between the casing and the mill bit, and
wherein the values indicative of the area of the interface between the casing and the mill bit are calculated using the values indicative of the incremental amount of volume of milled casing and rate-of-penetration.

5. The system of claim 2,
wherein the simulator is further programmed to simulate values indicative of an area of an interface between the casing and the mill bit,
wherein the values indicative of the area of the interface between the casing and the mill bit are calculated using simulated intersections of the volumes corresponding to an envelope of the bit with the volumes corresponding to the casing,
wherein the computer is further programmed to calculate depth-of-cut values in real-time using the values indicative of the area of the interface between the casing and the mill bit, and
wherein the controller is further programmed to adjust the operation of drilling equipment such that a difference between the depth-of-cut calculated in real-time and a predetermined target value is minimized.

6. The system of claim 2,
further comprising downhole sensors for measuring a weight-on-bit applied by the string, and a torque-on-bit applied by the string, and a rotation-per-minute, and
wherein the computer is programmed to calculate the mechanical specific energy values in real-time using the weight-on-bit and torque-on-bit, and the rotation-per-minute measured by the downhole sensors.

7. The system of claim 6,
wherein the controller is programmed to calculate target values for weight-on-bit applied by the string, and a torque-on-bit applied by the string such that a difference between the mechanical specific energy values calculated in real-time and a predetermined target value is minimized, and
wherein the controller is programmed to adjust operation of drilling equipment such that a difference between the weight-on-bit and torque-on-bit measured by the downhole sensors and the target values for torque-on-bit applied by the string are minimized.

8. A method for milling of an exit window through a casing using a whipstock, the method comprising:
providing data indicative of a position of a bit coupled to a string ;
providing a computer programmed to calculate mechanical specific energy values in real-time;
providing a controller programmed to adjust operation of drilling equipment such that a difference between the mechanical specific energy values calculated in real-time and a predetermined target value is minimized; and
controlling milling of the exit window using the computer and the controller.

9. The method of claim 8, further comprising providing a simulator capable of receiving data indicative of a position of a bit coupled to a string and programmed to simulate values indicative of an incremental amount of volume of milled casing, the method further comprising:
simulating volumes corresponding to an envelope of the bit using a whipstock geometry, and a profile of the bit, as a function of several values of the position of the bit;
simulating volumes corresponding to the casing using casing geometry,
wherein the values indicative of an incremental amount of volume of milled casing are calculated using simulated intersections of the volumes corresponding to an envelope of the bit with the volumes corresponding to the casing, and
wherein the computer is programmed to calculate the mechanical specific energy values in real-time using the values indicative of an incremental amount of volume of milled casing and drilling parameters measured during the milling of the exit window.

10. The system of claim 9, wherein the profile of the bit is approximated and includes at least a portion of a rectangle, an ellipsis, or a semi-circle.

11. The method of claim 9,
wherein the computer is programmed to calculate the mechanical specific energy values in real-time using values indicative of an area of an interface between the casing and the mill bit, and
wherein the values indicative of the area of the interface between the casing and the mill bit are calculated using the values indicative of the incremental amount of volume of milled casing and rate-of-penetration.

12. The method of claim 9,
wherein the simulator is further programmed to simulate values indicative of an area of an interface between the casing and the mill bit,
wherein the values indicative of the area of the interface between the casing and the mill bit are calculated using simulated intersections of the volumes corresponding to an envelope of the bit with the volumes corresponding to the casing,
wherein the computer is further programmed to calculate depth-of-cut values in real-time using the values indicative of the area of the interface between the casing and the mill bit, and
wherein the controller is further programmed to adjust the operation of drilling equipment such that a difference between the depth-of-cut calculated in real-time and a predetermined target value is minimized.

13. The method of claim 9, further comprising providing downhole sensors for measuring a weight-on-bit applied by the string, and a torque-on-bit applied by the string, and a rotation-per-minute, and
wherein the computer is programmed to calculate the mechanical specific energy values in real-time using the weight-on-bit and torque-on-bit, and the rotation-per-minute measured by the downhole sensors.

14. The method of claim 13,
wherein the controller is programmed to calculate target values for weight-on-bit applied by the string, and a torque-on-bit applied by the string such that a difference between the mechanical specific energy values calculated in real-time and a predetermined target value is minimized, and
wherein the controller is programmed to adjust operation of drilling equipment such that a difference between the weight-on-bit and torque-on-bit measured by the downhole sensors and the target values for torque-on-bit applied by the string are minimized.

15. A system for controlling drilling in a well, the system comprising:
a computer programmed to calculate mechanical specific energy values in real-time; and
a controller programmed to adjust operation of drilling equipment such that a difference between the mechanical specific energy values calculated in real-time and a predetermined target value is minimized.

16. The system of claim 15,
wherein the controller is programmed to calculate target values for weight-on-bit applied by the string, and a torque-on-bit applied by the string such that a difference between the mechanical specific energy values calculated in real-time and a predetermined target value is minimized, and
wherein the controller is programmed to adjust operation of drilling equipment such that a difference between the weight-on-bit and torque-on-bit measured by the downhole sensors and the target values for torque-on-bit applied by the string are minimized.

17. The system of claim 15, wherein the computer is programmed to calculate the mechanical specific energy values in real-time using a total volume of material swept by the mill bit and drilling parameters measured during the milling of the exit window, wherein the total volume of material includes casing, cement, and rock.

18. The system of claim 15, further comprising a sensor capable of measuring data indicative of a position of a bit coupled to a string.
